(19) United States
(12) Patent Application Publication
(10) Pub. No.: US 2021/0339102 A1
(43) Pub. Date: Nov. 4, 2021

(54) WATER SPRAYING DEVICE

(71) Applicants: Mark WILLIAMS, Whitby (CA); Jacqueline PRYCE, Stouffville (CA)

(72) Inventors: Mark WILLIAMS, Whitby (CA); Jacqueline PRYCE, Stouffville (CA)

(21) Appl. No.: 16/865,890

(22) Filed: May 4, 2020

(51) Int. Cl. A63B 63/08; B05B 12/00

(52) U.S. Cl. CPC A63B 63/083; A63B 2225/66; B05B 12/002

(57) ABSTRACT

A water spraying device is disclosed. The water spraying device includes a main housing, an actuator arm, and a sprayer assembly. The main housing is to be mounted to a basketball net. The actuator arm includes a proximal end pivotally mounted to the main housing and a distal end extending outwards from the main housing. The actuator arm is biased to a neutral position and pivotable to a depressed position responsive to downward force applied to the distal end of the actuator arm by a basketball. The sprayer assembly is mounted to the main housing, and includes a valve having a hose adapter on an inlet and a nozzle on an outlet of the valve. The valve is triggered to open responsive to the actuator arm pivoting to the depressed position.

### FIELD

The present application generally relates to water spraying devices and, more particularly, to water spraying devices for use with basketball nets.

### BACKGROUND

Basketball is an increasingly popular sport worldwide. It is played both professionally and recreationally, with the latter taking place in a variety of settings such as indoor court facilities and outdoor court surfaces.

Health research shows that a significant percentage of children do not get the recommended amount of daily activity, and, furthermore, certain childhood diseases linked to general inactivity are on the rise.

In the summertime, while playing basketball outdoors, some kids cut short their playing session due to discomfort from the heat. It would be beneficial to motivate kids to play basketball longer in order to increase their fitness levels and overall health.

### BRIEF DESCRIPTION OF THE DRAWINGS

Embodiments are described in detail below, with reference to the following drawings:

FIG. 1 is a perspective view of a basketball net with a water spraying device attached.

FIG. 2 is a perspective view of a water spraying device.

FIG. 3 is a perspective exploded component view of the water spraying device of FIG. 2.

FIG. 4A is a side view of the water spraying device of FIG. 2.

FIG. 4B is a lower perspective view of the water spraying device of FIG. 2.

FIG. 4C is a bottom view of the water spraying device of FIG. 2.

FIGS. 5A-B are cutaway views of the water spraying device of FIG. 4A in neutral and depressed states, respectively.

FIGS. 6A-B are side profile views of a basketball net with a water spraying device attached in neutral and depressed states, respectively.

FIG. 7A is a close-up view of the rim area of FIG. 6A with the water spraying device in a neutral state.

FIG. 7B is a close-up view of the rim area of FIG. 6B with the water spraying device in a depressed state.

Like reference numerals are used in the drawings to denote like elements and features.

### DETAILED DESCRIPTION

According to the subject matter of the present application, there may be provided a water spraying device. The water spraying device may include a main housing, an actuator arm, and a sprayer assembly. The main housing may be mounted to a basketball net. The actuator arm may include a proximal end pivotally mounted to the main housing and a distal end extending outwards from the main housing. The actuator arm may be biased to a neutral position and pivotable to a depressed position responsive to downward force applied to the distal end of the actuator arm by a basketball. The sprayer assembly may be mounted to the main housing. The sprayer assembly may include a valve having a hose adapter on an inlet and a nozzle on an outlet thereof. It may be that the valve is triggered to open responsive to the actuator arm pivoting to the depressed position. It may be that the actuator arm is resiliently biased to return to the neutral position.

In some implementations, the proximal end of the actuator arm engages the valve responsive to the actuator arm pivoting to the depressed position. It may be that the valve is a push button valve, and that the proximal end of the actuator arm includes a valve pusher shaped to actuate the push button valve upon the actuator arm pivoting to the depressed position.

In some implementations, the main housing may include a first bracket, and the sprayer assembly may be mounted to the first bracket. It may be that the first bracket includes an opening through which a push button of the push button valve protrudes to allow engagement between the valve pusher of the actuator arm and the push button valve.

In some implementations, the main housing may include a second bracket to which the actuator arm is pivotally mounted at the proximal end, and the second bracket may be mounted to the first bracket.

In some implementations, the water spraying device may comprise a flat pad disposed proximate the distal end of the actuator arm.

In some implementations, the flat pad of the actuator arm may include a pad edge guard attached around a periphery of the actuator arm. It may be that the pad edge guard is raised with respect to the flat pad of the actuator arm for urging basketballs onto the flat pad of the actuator arm as they pass through a rim of the basketball net upon which the water spraying device is mounted.

In some implementations, the flat pad may be situated below and centered on a rim of the basketball net upon which the water spraying device is mounted.

In some implementations, the water spraying device may comprise a pair of mounting clamps. It may be that the main housing is mounted by the pair of mounting clamps to a back plate of a rim of the basketball net upon which the water spraying device is mounted.

In some implementations, the water spraying device may comprise a pair of thumb screws. It may be that the pair of mounting clamps is attached to the main housing by the pair of thumb screws.

In some implementations, the water spraying device may comprise at least one zip-tie. It may be that the main housing is secured by the at least one zip-tie to one or more support arms of a rim of the basketball net upon which the water spraying device is mounted.

In some implementations, the sprayer assembly may be integrally formed so as to include the valve, the nozzle and the hose adapter.

In some implementations, the inlet of the valve may be for supplying water to the sprayer assembly. It may be that triggering of the valve to open, in use, causes the nozzle to spray water. It may be that the nozzle projects diagonally out of an opening of the main housing. It may be that the nozzle is configured so that water sprayed out of the nozzle falls substantially within a basketball key area below the basketball net upon which the water spraying device is mounted.

In some implementations, the nozzle may be configured to produce a fine mist.

Other aspects and features of the present application will be understood by those of ordinary skill in the art from a review of the following description in conjunction with the accompanying figures.

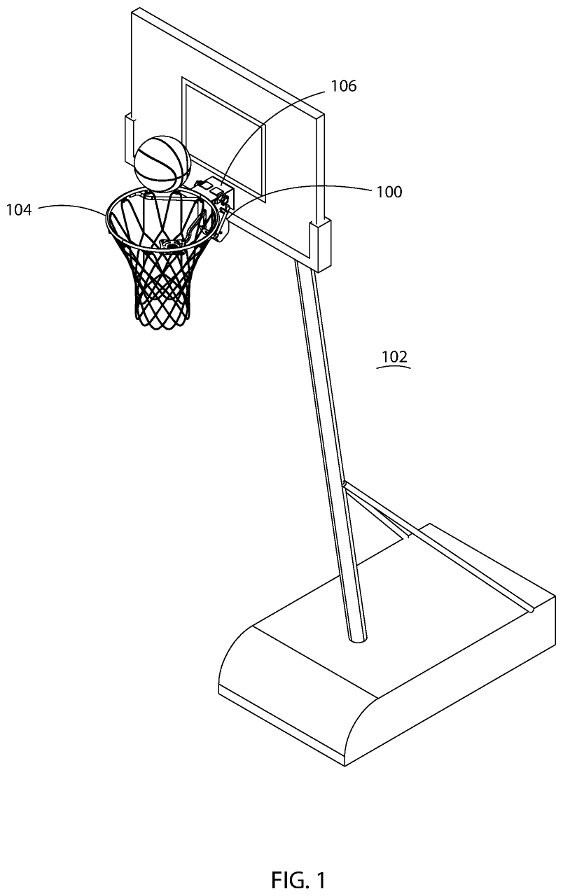

Reference is first made to FIG. 1 showing an example basketball net 102 which is commonly used for recreational use. A water spraying device 100, according to the subject-matter of the present application, is mounted to the rim 104 of the basketball net 102. In one example embodiment, the water spraying device 100 may be mounted to a back plate 106 of the rim. The type of basketball net 102 shown in FIG. 1 is typical for home use, but it will be appreciated that the water spraying device 100 can be retrofitted onto any type of basketball net including, for example, indoor sports facility nets, outdoor court nets, floating swimming pool nets, and the like.

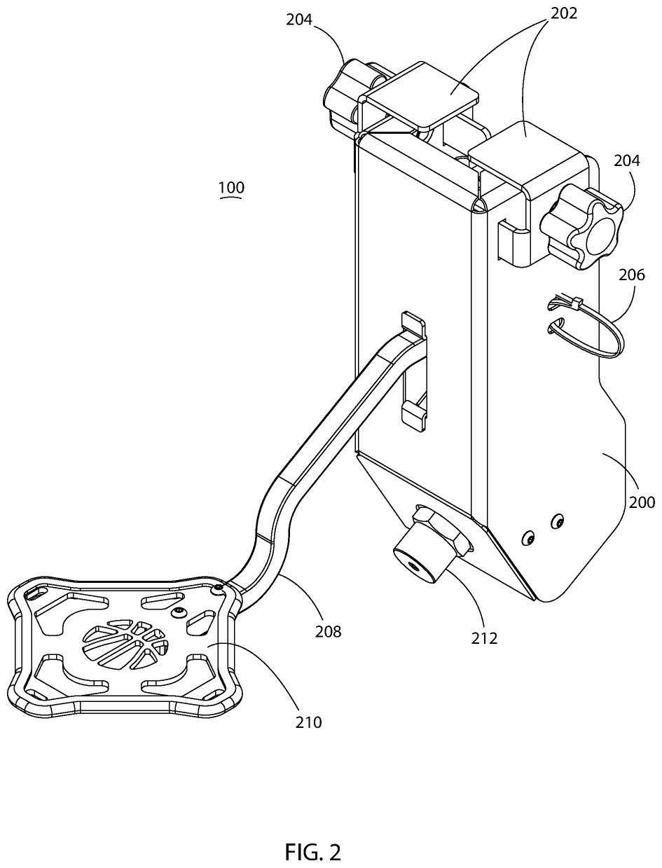

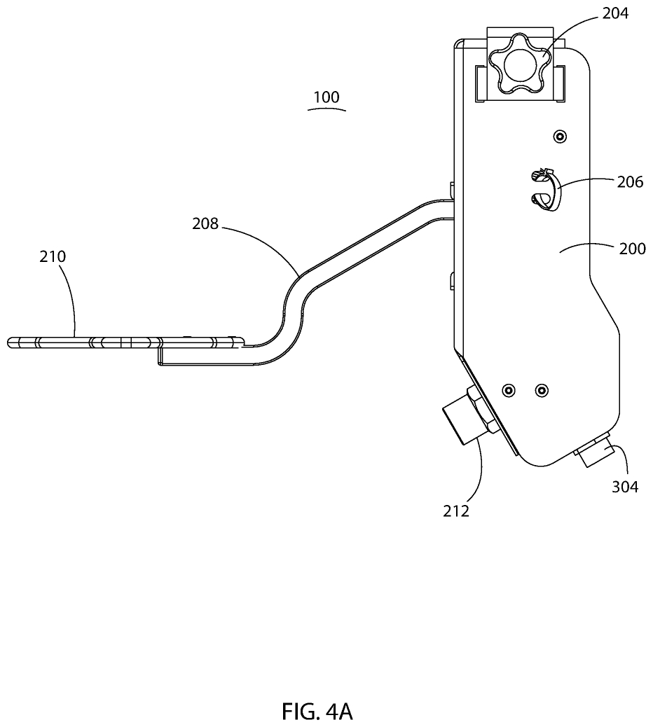

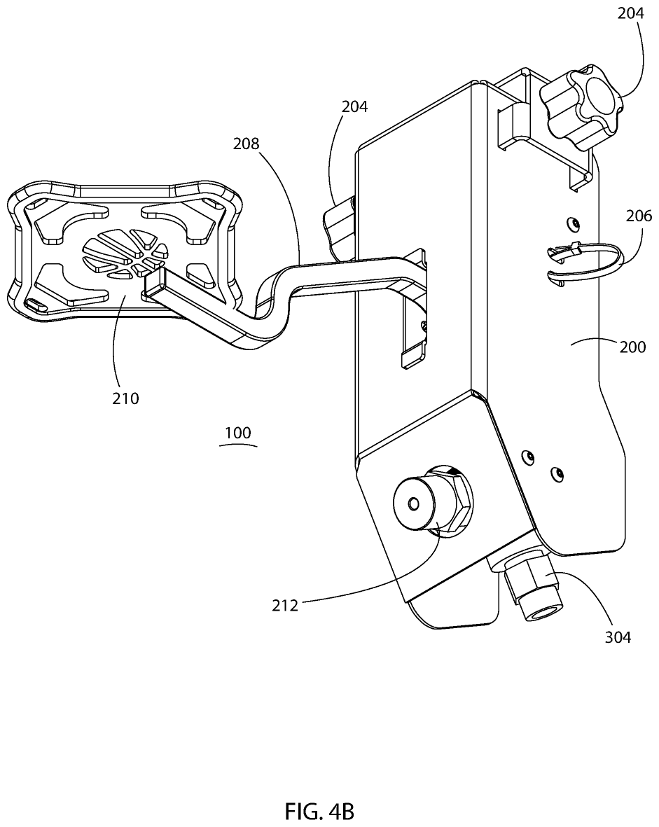

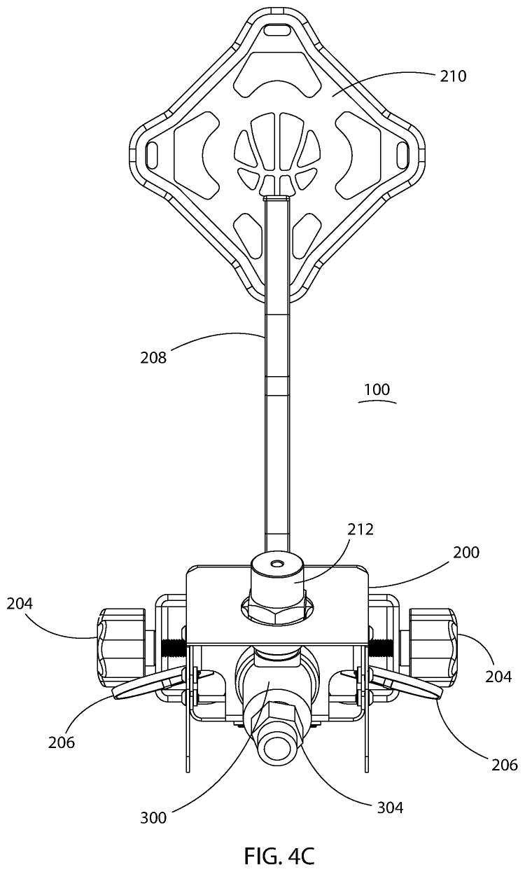

An example implementation will now be discussed with reference to FIG. 2 which provides a perspective view of the water spraying device 100. Corresponding side, lower perspective, and bottom views of the water spraying device 100 are provided in FIGS. 4A, 4B and 4C, respectively. The water spraying device 100 may, for example and as shown, have a main housing 200 encompassing one or more hidden device components (described below). These hidden components may thereby be protected from damage or premature wear resulting from, for example, wayward basketball shots or inclement weather. The main housing 200 may be mounted to a basketball net rim, such as that of the basketball net 102 of FIG. 1, by way of, for example, mounting clamps 202. These mounting clamps 202 on either side of the water spraying device 100 would slide over a flat portion (back plate) of the basketball net rim and into receiving cut-outs on the main housing 200. In addition, a pair of thumb screws 204 may be used for securing the mounting clamps 202 to the main housing 200 and to the basketball net rim. The thumb screws 204 may screw into threaded slots in both the mounting clamps 202 and the main housing 200. Additionally, or alternatively, at least one zip-tie 206 on either side of the water spraying device 100 may be used for securing the main housing 200 to one or more support arms of a basketball net rim. These zip-ties 206 may also function as a fail-safe mechanism in case the primary mounting means unexpectedly fail. An actuator arm 208 is pivotally mounted to the main housing at a proximal end of the actuator arm, i.e. nearest the water spraying device 100. In an example embodiment, the water spraying device 100 includes a flat pad 210 disposed proximate a distal end of the actuator arm 208, i.e. furthest from the water spraying device 100, to receive downward force applied by a basketball. It will be appreciated that the flat pad 210 may be provided in various shapes and configurations, and that, in fact, no flat pad 210 may be used. Indeed, the distal end of the actuator arm 208 may instead take the form of a conventional basketball return.

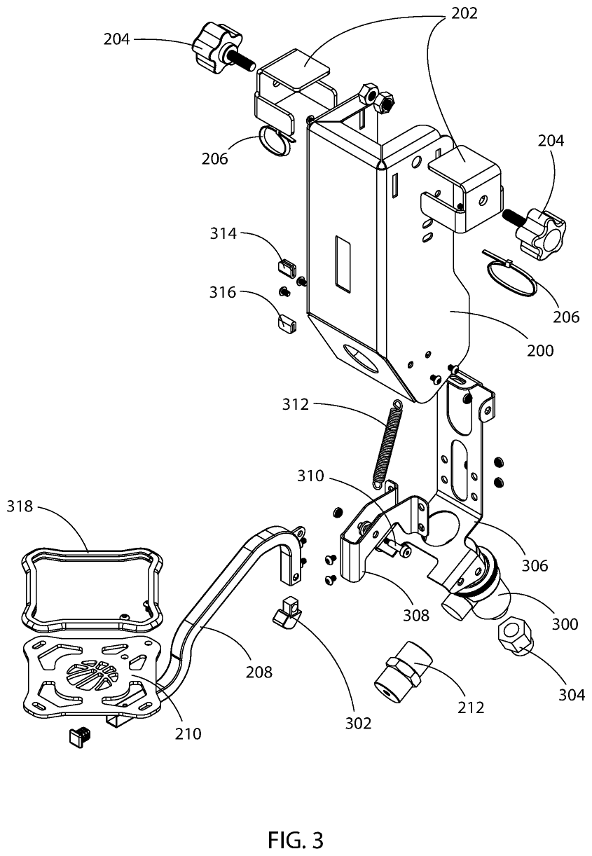

FIG. 3 provides a perspective exploded view of the water spraying device 100 showing the various constituent components, including components which are hidden from view when the water spraying device 100 is assembled as shown in FIGS. 2 and 4A-4C. In particular, a main housing 200 may serve as a shell of the device and encompass: the actuator arm 208 (partially), a valve 300, a valve pusher 302, a hose adapter 304, a nozzle 212 (partially), a first bracket 306, a second bracket 308, a shoulder screw 310, and a biasing means 312. As regards the first bracket 306, it may be that a sprayer assembly including the valve 300 is mounted to the first bracket 306, and that the first bracket 306 includes an opening through which the valve 300 protrudes to allow engagement between the actuator arm 208 and the valve 300. The first bracket 306 mounts to the main housing 200 during device assembly. As regards the second bracket 308, it pivotally mounts the actuator arm 208 at the proximal end using the shoulder screw 310, and is mounted to the first bracket 306 during device assembly. As regards the biasing means 312, it may include one or more springs and/or any resilient member(s) suitable for biasing the actuator arm 208. The biasing means 312 attaches on one end to the first bracket 306, and on its other end to the actuator arm 208. The water spraying device 100 may also have an upper pad stopper 314 and lower pad stopper 316 for limiting movement of the actuator arm 208 and/or protecting the main housing 200 opening through which the actuator arm 208 protrudes. A pad edge guard 318 may be attached around a periphery of the flat pad 210 of the actuator arm 208. The pad edge guard 318 may be raised with respect to the flat pad 210 for urging basketballs onto the flat pad 210 of the actuator arm 208 as they pass through a rim of a basketball net upon which the water spraying device 100 is mounted.

As perhaps best shown in FIG. 4C, the water spraying device 100 includes a sprayer assembly having a valve 300 mounted within the main housing 200. On the valve 300 is found a hose adapter 304 on an inlet of the valve 300 for supplying water to the sprayer assembly from a hose, such as, for example, a conventional garden hose. The valve 300 also has a nozzle 212 on an outlet of the valve 300 for spraying water. In one example embodiment, the sprayer assembly is integrally formed so as to include the valve 300, the nozzle 212 and the hose adapter 304, e.g. formed in a pre-machined mold by injection molding, multi-material injection molding, or other such processes.

The components of the water spraying device 100 may be formed of various materials, such as, for example, metal, plastic, rubber, other polymers, or any combination of materials.

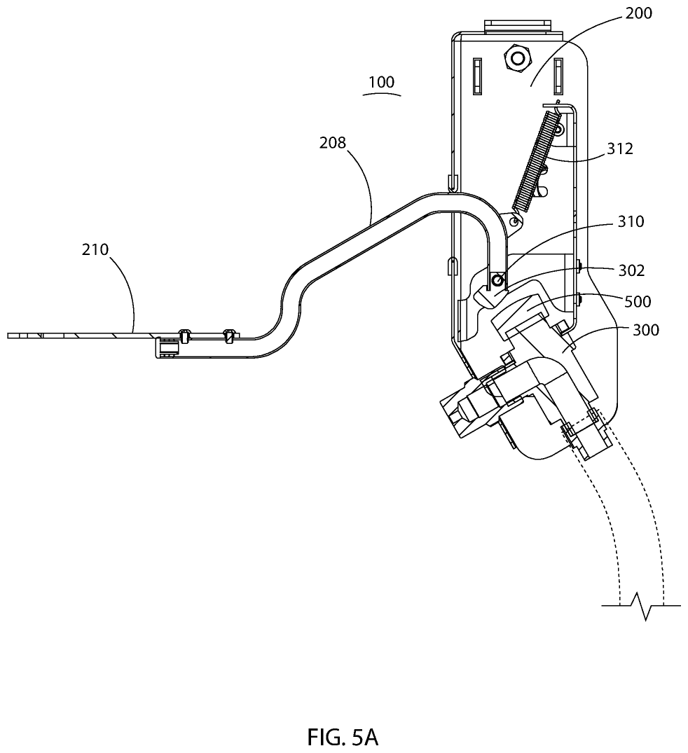

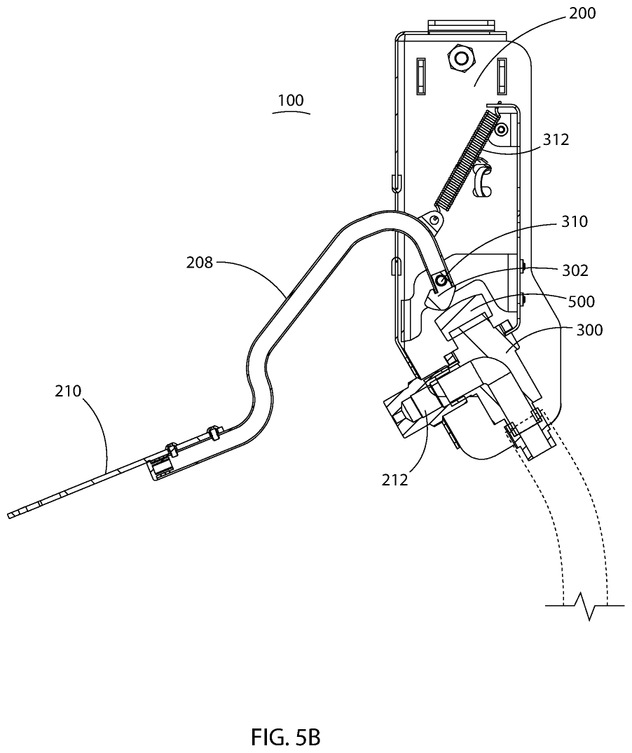

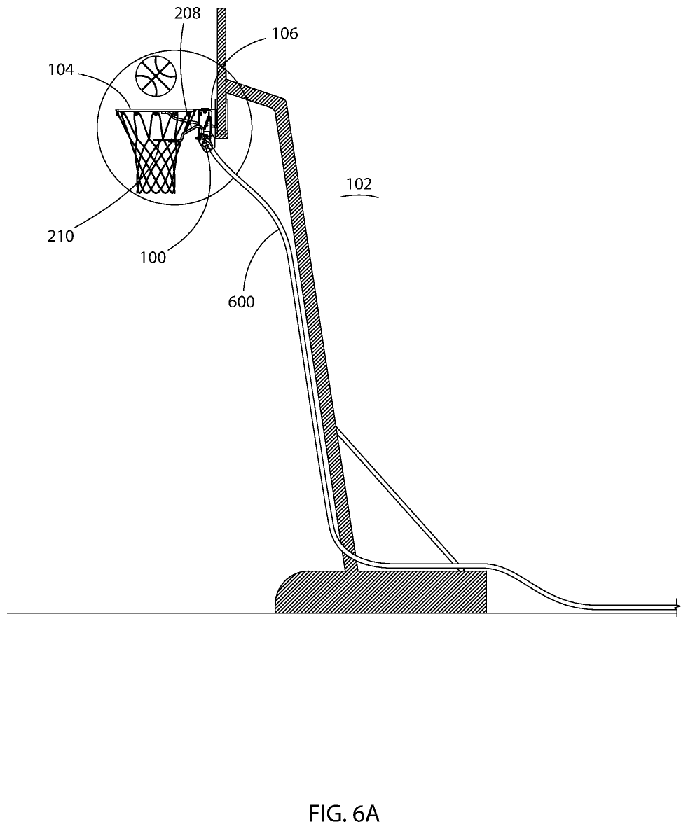

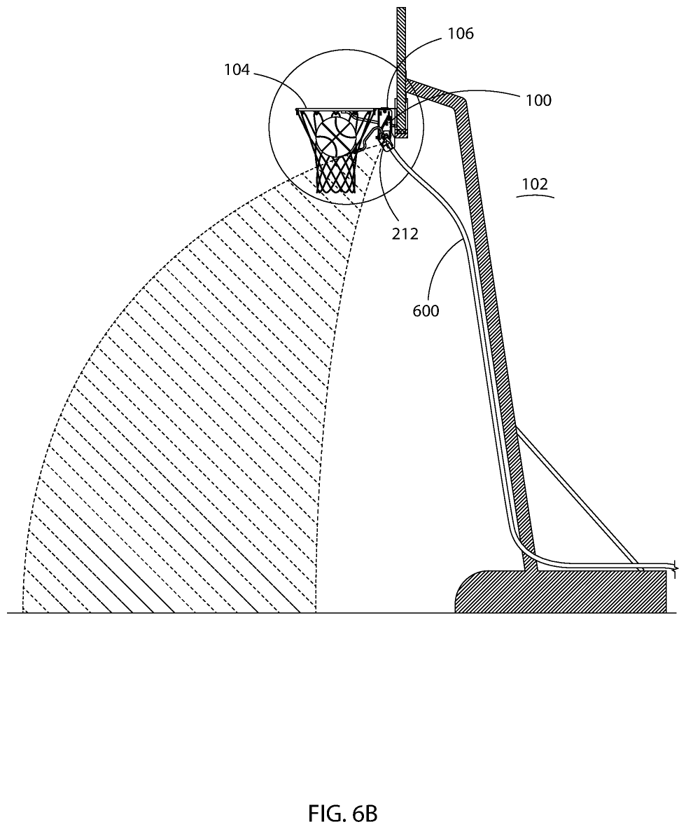

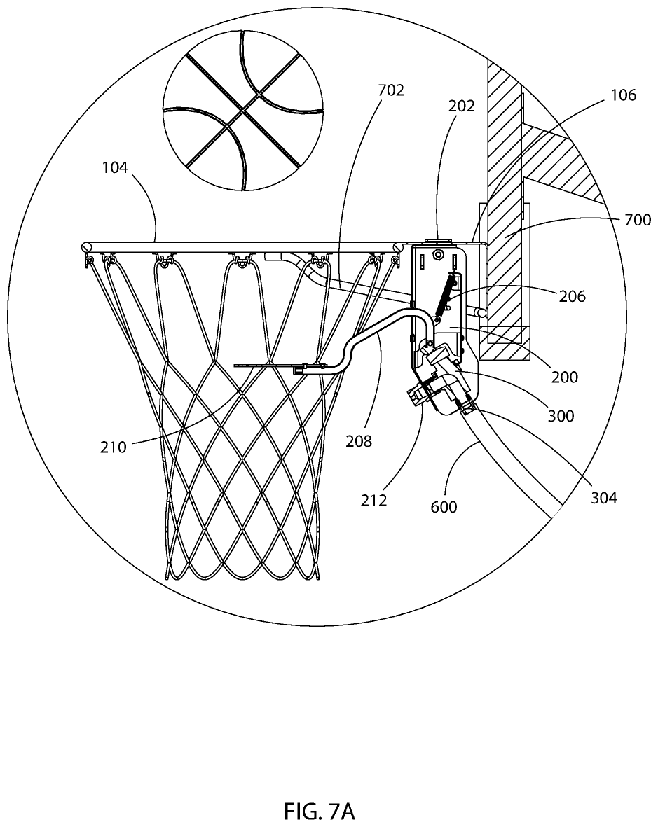

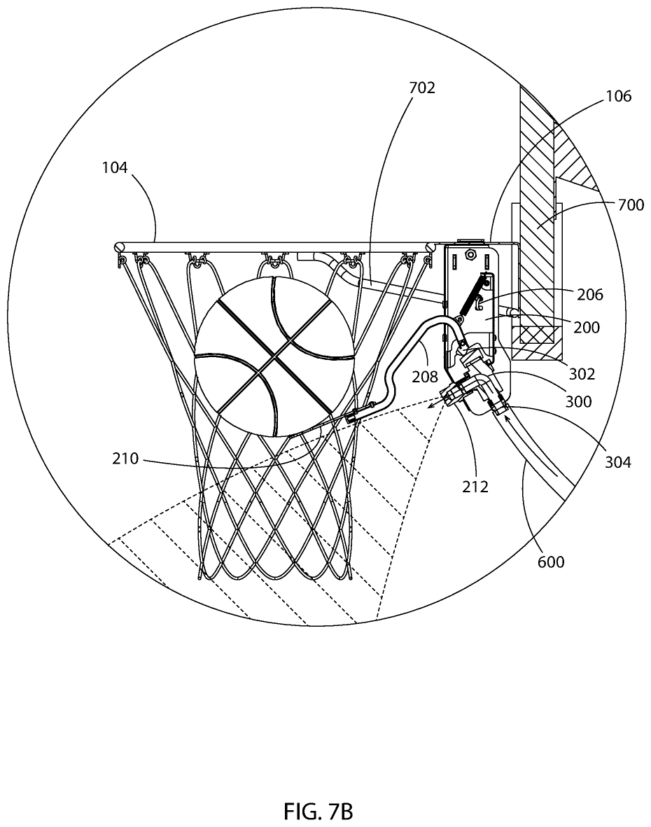

FIGS. 5A-5B are cutaway views of the water spraying device 100 in neutral and depressed states, respectively, and showing the actuator arm 208 pivoting between a neutral position and a depressed position. FIGS. 6A-6B are side profile views of a basketball net 102 with a mounted water spraying device 100 in neutral and depressed states, respectively, corresponding to FIGS. 5A-5B. FIGS. 7A-7B are close-up views of the rim 104 area of FIGS. 6A-6B, respectively, with the mounted water spraying device 100 in neutral and depressed states, respectively.

FIG. 5A provides a cutaway view of the water spraying device 100 in a neutral state. In this state, the actuator arm 208 is resiliently biased to a neutral (i.e. resting) position by biasing means 312. Put another way, the actuator arm 208 will remain in the neutral position unless sufficient force is applied to it, and will return to the neutral position when force is removed from it. In the embodiments shown, biasing means 312 is a coil spring. As perhaps best shown in FIG. 7A, the device main housing 200 is mounted to the back plate 106 of the basketball net 102 rim 104 by a pair of mounting clamps 202 (only the back-side clamp is shown for ease of illustration). The back plate 106 is that horizontal portion of the rim 104 that connects the rim 104 to the basketball net backboard 700. As shown in FIG. 6A and FIG. 7A, a typical household garden hose 600 may be connected to the valve 300 inlet (at hose adapter 304) for supplying water to the sprayer assembly of water spraying device 100. In the example embodiment shown, the flat pad 210 of the actuator arm 208 is situated below and centered on the rim 104 of the basketball net 102 upon which the water spraying device 100 is mounted.

FIG. 5B provides a cutaway view of the water spraying device 100 in a depressed state. In this state, the actuator arm 208 has pivoted about the shoulder screw 310 to a depressed position due to downward force applied to the flat pad 210 at the distal end of the actuator arm 208 by a basketball. As shown, the biasing means 312 (spring) is extended by the actuator arm 208. The proximal end of the actuator arm 208 may engage the valve 300 responsive to the actuator arm 208 pivoting to the depressed position. In the example embodiment of FIG. 5B, the valve 300 is a push button valve 300, and the proximal end of the actuator arm 208 includes a valve pusher 302 shaped to actuate the push button valve 300 upon the actuator arm 208 pivoting to the depressed position. Actuation of the valve 300 may occur, for example, by pushing down on a push button 500 of the push button valve 300. It will be appreciated that the present water spraying device 100 is not limited to using a push button valve 300, but that any suitable type of valve which can be triggered to open by a pivoting action of the actuator arm 208 may be used. Furthermore, any suitable shape of valve pusher may be chosen to correspond with the actuation mechanism of the chosen valve type. The valve pusher 302 may also be integrally formed with the actuator arm 208 at its proximal end, or alternatively, may be an individual piece connected thereto.

As described above, and as perhaps best shown in FIG. 7B, the valve 300 is triggered to open responsive to the actuator arm 208 pivoting to the depressed position. As a result, water flows in the valve 300 inlet and out the valve 300 outlet. That is, triggering of the valve 300 to open, in use, causes the nozzle 212 to spray water. As shown, safety zip-tie 206 may help secure the main housing 200 to one or more support arms 702 of the basketball net rim 104 (only the back-side support arm is shown for ease of illustration). In one embodiment, the nozzle 212 projects diagonally out of an opening of the main housing 200, and in another embodiment the nozzle 212 may be configured to produce a fine mist. A fine mist may be desirable so as to cool down and/or refresh the players without overly saturating the basketball court. In an example embodiment depicted in FIG. 6B, the spraying device nozzle 212 is configured so that water sprayed out of the nozzle 212 falls substantially within a basketball key area below the basketball net 102 upon which the water spraying device 100 is mounted. This may be desirable in order not to waste water spraying areas in which no players are located, as the players are most likely within the key area, especially in, for example, a home use setting.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

As noted, certain adaptations and modifications of the described embodiments can be made. Therefore, the above-discussed embodiments are considered to be illustrative and not restrictive.

What is claimed is:

1. A water spraying device comprising:
a main housing to be mounted to a basketball net;
an actuator arm including a proximal end pivotally mounted to the main housing and a distal end extending outwards from the main housing, the actuator arm biased to a neutral position and pivotable to a depressed position responsive to downward force applied to the distal end of the actuator arm by a basketball; and
a sprayer assembly mounted to the main housing, the sprayer assembly including a valve having a hose adapter on an inlet and a nozzle on an outlet thereof,
wherein the valve is triggered to open responsive to the actuator arm pivoting to the depressed position.

2. The water spraying device of claim 1, wherein the proximal end of the actuator arm engages the valve responsive to the actuator arm pivoting to the depressed position.

3. The water spraying device of claim 2, wherein the valve is a push button valve, and wherein the proximal end of the actuator arm includes a valve pusher shaped to actuate the push button valve upon the actuator arm pivoting to the depressed position.

4. The water spraying device of claim 3, wherein the main housing includes a first bracket, and wherein the sprayer assembly is mounted to the first bracket.

5. The water spraying device of claim 4, wherein the first bracket includes an opening through which a push button of the push button valve protrudes to allow engagement between the valve pusher and the push button valve.

6. The water spraying device of claim 5, wherein the main housing includes a second bracket to which the actuator arm is pivotally mounted at the proximal end, and wherein the second bracket is mounted to the first bracket.

7. The water spraying device of claim 1, wherein the actuator arm is resiliently biased to return to the neutral position.

8. The water spraying device of claim 1, wherein the water spraying device further comprises a flat pad disposed proximate the distal end of the actuator arm.

9. The water spraying device of claim 8, wherein the flat pad of the actuator arm includes a pad edge guard attached around a periphery thereof.

10. The water spraying device of claim 9, wherein the pad edge guard is raised with respect to the flat pad of the actuator arm for urging basketballs onto the flat pad of the actuator arm as they pass through a rim of the basketball net upon which the water spraying device is mounted.

11. The water spraying device of claim 9, wherein the flat pad is situated below and centered on a rim of the basketball net upon which the water spraying device is mounted.

12. The water spraying device of claim 1, the water spraying device further comprising a pair of mounting clamps, the main housing to be mounted by the pair of mounting clamps to a back plate of a rim of the basketball net upon which the water spraying device is mounted.

13. The water spraying device of claim 12, the water spraying device further comprising a pair of thumb screws, the pair of mounting clamps to be attached to the main housing by the pair of thumb screws.

14. The water spraying device of claim 1, the water spraying device further comprising at least one zip-tie, the main housing to be secured by the at least one zip-tie to one or more support arms of a rim of the basketball net upon which the water spraying device is mounted.

15. The water spraying device of claim 1, wherein the sprayer assembly is integrally formed so as to include the valve, the nozzle and the hose adapter.

16. The water spraying device of claim 1, wherein the inlet of the valve is for supplying water to the sprayer assembly.

17. The water spraying device of claim 16, wherein triggering of the valve to open, in use, causes the nozzle to spray water.

18. The water spraying device of claim 17, wherein the nozzle projects diagonally out of an opening of the main housing.

19. The water spraying device of claim 18, wherein the nozzle is configured so that water sprayed out of the nozzle falls substantially within a basketball key area below the basketball net upon which the water spraying device is mounted.

20. The water spraying device of claim 17, wherein the nozzle is configured to produce a fine mist.
